(19) United States
(12) Patent Application Publication
(10) Pub. No.: US 2024/0232980 A1
(43) Pub. Date: Jul. 11, 2024

(54) COMPLEMENTARY APPAREL RECOMMENDATION SYSTEM

(71) Applicant: Walmart Apollo, LLC, Bentonville, AR (US)

(72) Inventors: He Wen, Menlo Park, CA (US); Sean Christopher D. Rosario, Sunnyvale, CA (US); Yanmin Liu, Bentonville, AR (US)

(21) Appl. No.: 18/407,455

(22) Filed: Jan. 9, 2024

Related U.S. Application Data
(60) Provisional application No. 63/479,437, filed on Jan. 11, 2023.

(51) Int. Cl. G06Q 30/0601

(52) U.S. Cl. CPC G06Q 30/0631

(57) ABSTRACT

Examples provide a system and method for recommending complementary apparel items based on an image of a model wearing an anchor item of apparel. A recommendation manager identifies the category of the complementary item. A per-category similarity definition is used to identify category-specific features used to determine whether a candidate item in the same category as the complementary item is the same or similar to the complementary item. A pre-trained machine learning model is used to calculate feature vectors representing the complementary item and each candidate item. The feature vectors are generated by concatenating feature vector values representing each feature in the plurality of category-specific features for the identified category. The candidates are ranked based on the feature vector values. The highest-ranking candidate items having the greatest degree of similarity to the complementary item are added to a list of recommended items presented to the user.

### BACKGROUND

When shopping online, a user frequently views apparel items in images of a model wearing a selected apparel item along with other complementary apparel items. For example, if a user is shopping for a red shirt, the red shirt may be shown on a product display page in an image of a human model wearing the red shirt with a pair of khaki pants. After viewing the image, the user may wish to purchase both the red shirt and the khaki pants to have the complete outfit. In such cases, the user typically has to manually search the online catalog to find similar khaki pants. Moreover, the user may fail to identify similar pants even after a thorough search due to items being out-of-stock or use of sub-optimal search terms. This can be a time-consuming and frustrating process for the user.

### SUMMARY

Some examples provide a system and method for recommending complementary items using image detection and matching. A recommendation manager identifies the category of a complementary item appearing in an image of a selected item on a product display page (PDP) on a user interface device. The recommendation manager retrieves a per-category similarity definition. The definition includes a plurality of category-specific features for determining a degree of similarity between items within the identified category. The recommendation manager calculates a feature vector representing the complementary item and feature vectors representing candidate items from the same category. The feature vector is generated by concatenating feature vector values representing each of the category-specific features for the identified category. The recommendation manager ranks each candidate item based on the similarity distance between the feature vector values of candidate and selected apparel image. The rank indicates the degree of similarity between the complementary item and each candidate item. Each candidate item having a rank that exceeds a threshold value is added to a list of recommended items which are available for purchase and complementary to the selected item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for recommending complementary apparel items using object detection and matching.

FIG. 2 is an exemplary block diagram illustrating a recommendation manager that generates recommended complementary items using machine learning (ML) models.

FIG. 3 is an exemplary block diagram illustrating a recommendation manager including pre-trained ML models for detecting and matching apparel objects.

FIG. 4 is an exemplary block diagram illustrating per-category similarity definitions.

FIG. 5 is an exemplary diagram illustrating object detection using a full-body image of a human model including complementary apparel items.

FIG. 6 is an exemplary diagram illustrating matching of similar items with a complementary item shown in a cropped image.

FIG. 7 is an exemplary diagram illustrating attribute feature extraction of an image of a complementary item.

FIG. 8 is an exemplary diagram illustrating feature vector generation for an item of apparel depicted in an image.

FIG. 9 is an exemplary diagram illustrating rankings for a plurality of candidate items.

FIG. 10 is an exemplary diagram illustrating a selected full-body image and a list of recommended items in a PDP.

FIG. 11 is an exemplary flow chart illustrating operation of the computing device to identify apparel items similar to a complementary item in an image.

FIG. 12 is an exemplary flow chart illustrating operation of the computing device to identify the top ranked similar items for recommendation to a user.

FIG. 13 is an exemplary graph illustrating cosine similarity between concatenated feature vectors of two items.

FIG. 14 is an exemplary block diagram representing a system architecture for generating similar item recommendations.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

When viewing a user-selected item of apparel in a product description page or other item description page including a human model wearing the user-selected item, the customer could be interested in purchasing other complementary items of apparel shown on the human model in order to complete the look.

However, locating the same complementary item shown on the model or other similar items of apparel can be time-consuming. Moreover, a user may lose interest if the manual search takes too long. This can lead to lost sales, customer dissatisfaction, as well as wasted computing system resources consumed during the manual search of the online apparel catalogs.

Some systems permit a user to upload a photo of a desired item. The system then searches for the same item shown in the image. Most of these systems can only identify the exact same item and are unable to identify complementary items. In other cases, systems frequently are unable to accurately detect and classify both clothing and footwear. This renders the system's recommendations unhelpful for some users resulting in loss of time and sub-optimal usage of system resources.

Referring to the figures, examples of the disclosure enable a recommendation system for recommending complementary apparel items. In some examples, a pre-trained machine learning model utilizes per-category specific similarity definitions to determine the degree of similarity between items within a catalog. This enables more accurate identification of items which are the same or similar to an apparel item in an image for improved accuracy and reliability of results.

Aspects of the disclosure enable a shoe-detection machine learning (ML) model using custom-trained convolutional neural networks to identify shoe items within an image. The ML model places bounding boxes around each shoe in the image, enabling the image of the shoes to be cropped for later analysis and identification of other shoe items in the catalog which are the same or similar to the shoes in the image. This enables greater flexibility and breadth of apparel items which may be candidates for the recommendations.

In still other aspects, the system recommends apparel items which are the same or similar to apparel items seen in images on a PDP to the customer. This helps customers quickly find the complimentary items in a full-body fashion model image, such as tops, pants, shoes, scarves, bags, vests, etc. It further reduces manual curation by merchandizing teams.

In yet other examples, the system suggests relevant apparel items that have matching fashion styles to a complementary item shown on a human model. This saves the customer time by visually searching for these items in a product catalog and provides customers with an interesting shopping experience. The recommendations provided during the online shopping experience further make it easier for customers to add complimentary products to the cart or favorite list for increased customer engagement and loyalty.

The recommendation manager utilizes pre-trained machine learning models to generate various features of complementary items with greater accuracy and reliability. This enables complementary item recommendations to customers which are more likely to be acceptable to the customer, which improves user efficiency via the user interface interaction and increases user interaction performance.

The computing device operates in an unconventional manner by reducing the time users spend searching online catalogs for complementary items, thereby reducing the amount of time and system resource usage consumed during online shopping. In this manner, the computing device operates in an unconventional manner by reducing processor and network bandwidth usage to improve overall system efficiency.

The system further generates more relevant search results which reduces system processor usage and network bandwidth usage by reducing the number of searches performed by the user as well as reducing the number of search requests processed by the system. Moreover, the system reduces the number of irrelevant search results returned to the user for increased speed in resolving queries as well as reducing processor load.

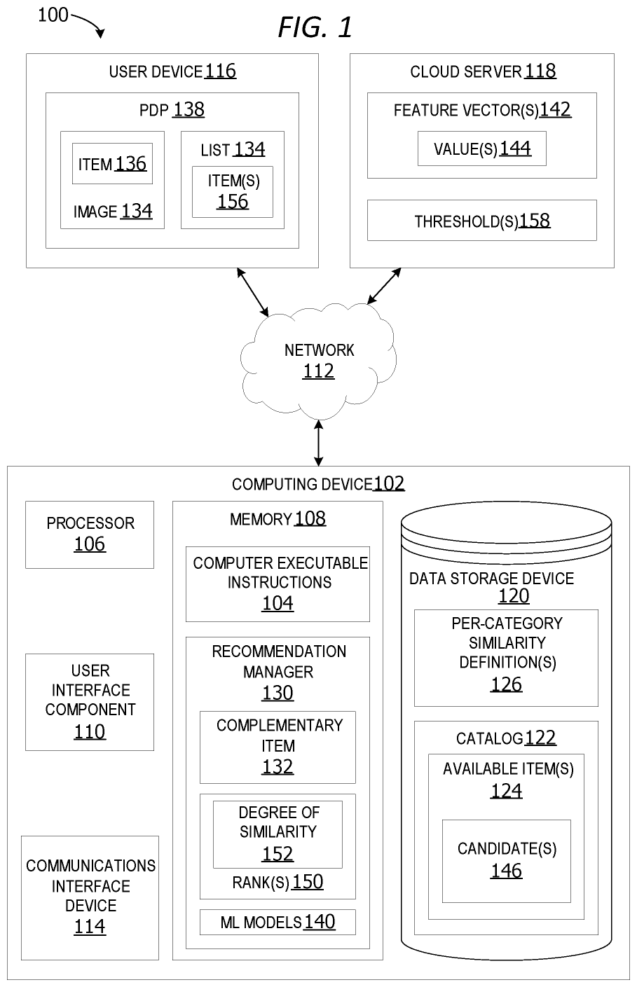

Referring again to FIG. 1, an exemplary block diagram illustrates a system 100 for recommending complementary apparel items using object detection and matching. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

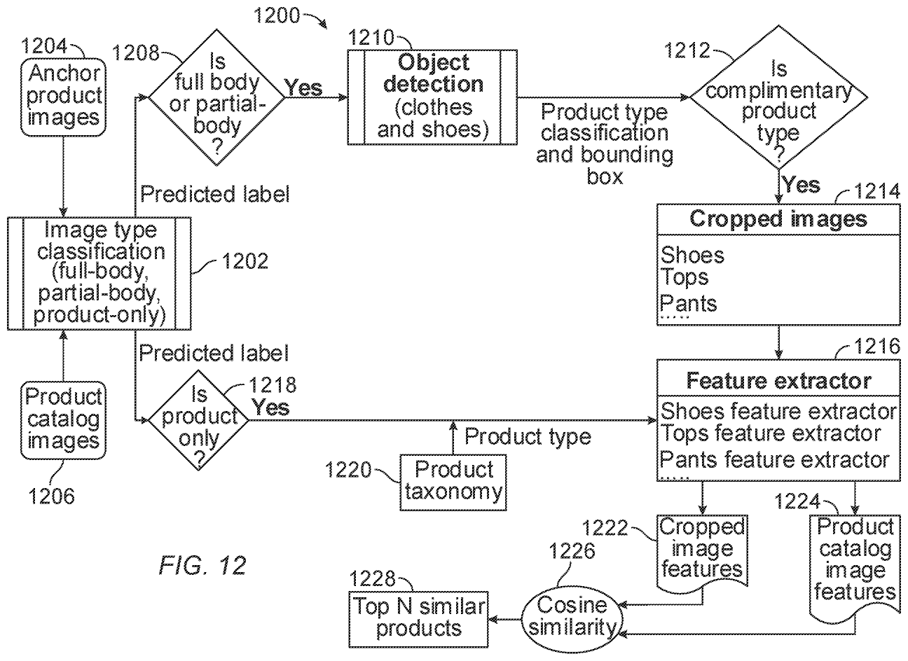

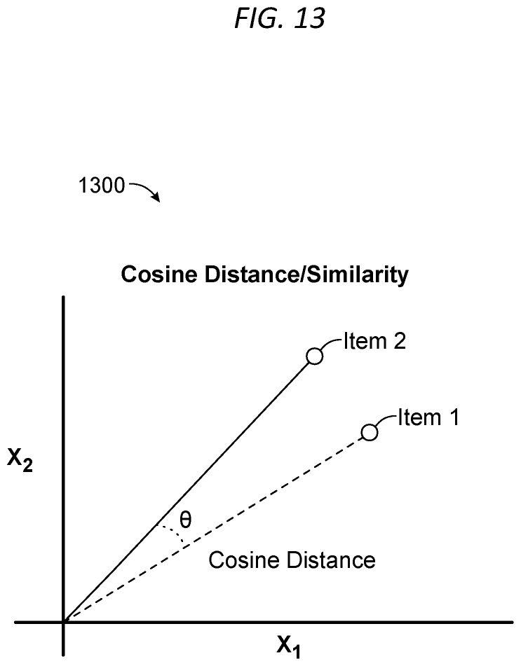

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIGS. 12 and 13).

The computing device 102 further has one or more computer-readable media such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network devices, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to a catalog 122 of available item(s) 124. The available item(s) 124 in some examples include apparel items, such as shirts, pants, skirts, dresses, shoes, and other items of clothing and footwear. The data storage device 120 in other examples stores per-category similarity definition(s) 126 defining sets of features used to determine whether a candidate item is the same or similar to a complementary item. The feature(s) 128 includes features used to describe different categories of apparel, such as, but not limited to, color, color line, sleeve length, pant length, fabric/material, shape, etc. In some examples, the system maps definitions, features and/or different item category types. The mapping is utilized to predict complementary items based on features and category types of the items.

The data storage device 120 can include one or more different types of data storage devices, such as, for example, one or more rotating disks drives, one or more solid state drives (SSDs), and/or any other type of data storage device. The data storage device 120 in some non-limiting examples includes a redundant array of independent disks (RAID) array. In other examples, the data storage device 120 includes a database.

The data storage device 120 in this example is included within the computing device 102, attached to the computing device, plugged into the computing device, or otherwise associated with the computing device 102. In other examples, the data storage device 120 includes a remote data storage accessed by the computing device via the network 112, such as a remote data storage device, a data storage in a remote data center, or a cloud storage.

The memory 108 in some examples stores one or more computer-executable components. Exemplary components include a recommendation manager 130. The recommendation manager 130, when executed by the processor 106 of the computing device 102, identifies a category of a complementary item 132 appearing in an image 134 of a selected item 136 on a product display page (PDP) 138.

The selected item 136 is an item selected by the user, such as when the user selects an item to view in a product description page, when the user selects an item to view in additional images of the item, and/or when the user places an item into a cart while shopping via an online webpage or other online catalog of items available for purchase. For example, if a user is looking at shirts in an online catalog and selects a red t-shirt from the catalog page, a product description page is then displayed for the selected item (red t-shirt). The product description page shows the selected item in one or more images and/or includes a written description of the selected item. The product description page alternatively includes user reviews of the selected item, available sizes of the selected item, an option to place the selected item into a virtual shopping cart, etc.

The recommendation manager 130 retrieves a per-category similarity definition 126 for the category of the selected item. The definition includes category-specific features 128 for determining a degree of similarity between items within the identified category.

The recommendation manager in other examples includes ML models 140 for identifying available items which are the same or similar to the complementary item 132. In some examples, the recommendation manager uses the ML models 140 to calculate feature vector(s) 142 representing the complementary item 132 and candidate(s) 146. The candidate(s) 146 includes one or more candidate items in the plurality of available items within the catalog 122 which fall within the same category as the complementary item 132.

The candidate(s) are in a different category than the selected item. For example, if the selected item is a shirt, the complementary item can be a skirt, shoes, bag, scarf, or other different type of apparel item that can be worn with the shirt. In another example, if the selected item is a pair of shoes, the complementary item can be pants, a skirt, a shirt, a hat, etc. The candidate items are items in the same category as a complementary item but a different category than the selected item.

In some examples, the feature vector(s) are calculated by concatenating a plurality of feature vector values 144 representing the plurality of category-specific features 128 for the identified category. A candidate item is an item in the identified category that is available for purchase.

In still other examples, the recommendation manager 130 uses the feature vector(s) 142 for each candidate item to generate a rank for each candidate. The rank(s) 150 indicates the degree of similarity 152 between the complementary item and each candidate item. The recommendation manager 130 generates a list 154 of recommended items 156. Each item in the list 154 is a candidate item having a rank exceeding a threshold 158 value.

In some examples, a threshold number of items on the recommended items list are presented to the user via the PDP. For example, the list of recommended items can include the top three most similar items for each complementary item.

In other examples, the cloud server 118 hosts the recommendation manager. In these examples, the cloud server 118 calculates the feature vector values and/or determines the ranks for each candidate item more efficiently.

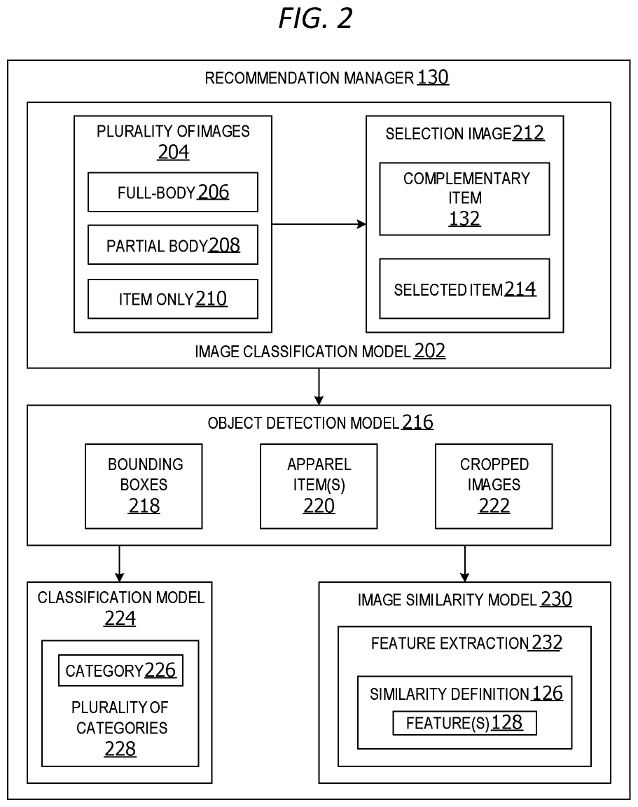

FIG. 2 is an exemplary block diagram illustrating a recommendation manager 130 that generates recommended complementary items using machine learning (ML) models. In some examples, the recommendation manager 130 includes an image classification model 202. The image classification model 202 analyzes a plurality of images from the product catalog associated with an anchor item which is complementary to a selected item the user is viewing or the user has selected for purchase. The anchor item is a specific complementary item which is shown in a full-body image of a human model wearing the selected item and/or visible in a partial-body image of the selected item for which the system is attempting to identify a same or similar apparel item to suggest as a recommendation to the user.

For example, if a full-body image of a human model wearing an item selected by a user, such as a pair of denim pants, also shows a pair of white shoes and a blue shirt. The blue shirt and the white shoes are both complementary items to the selected pair of denim pants. When the system is using images of the complementary white shoes to find the same or similar pairs of white shoes for recommendation to the user, the image of the white shoes in the original full-body image is referred to as an anchor item. The full-body image showing the white shoes is an anchor image used during the image classification and recommendation process. If the system is generating recommendations of same or similar apparel items for the complementary blue shirt, the blue shirt is the anchor item and the full-body image of the model wearing the denim pants and blue shirt is the anchor image.

In some examples, the anchor item is shown in a full-body 206 image. A full-body image is an image of the selected item and the complementary item on a model in which the model is shown from head to foot. Partial body 208 images include a portion of the human model wearing the anchor item. The partial body image in one example includes the human model from the waist up but omits the model's feet and lower limbs. Some partial body images do not include the anchor item and are not used during the classification and recommendation process. The item only 210 image is an image of the item without the presence of a human model in the image. The item only (product-only) image does not include the selected item or the anchor item.

The image classification model 202 is a ML model, such as, but not limited to, the ML models 140. The image classification model 202 classifies each image in the plurality of images 204 as an item only 210 image, a partial body 208 image and/or a full-body 206 image. A full-body 206 image including a human model wearing the selected item 214 and at least one complementary item 132 is chosen as the selected image 212.

The image classification label assigned to each image enables the system to select an anchor image. An anchor image is an image including the selected item and at least one complementary item for further analysis of complementary items. In some examples, the selected image is a full-body image. However, in other examples, the selected image is a partial body image where a preferred full-body image is unavailable. The selected image 212 is passed from the image classification model 202 to the object detection model 216.

The object detection model 216 is an ML model, such as the ML models 140 in FIG. 1. In some examples, the object detection model 216 places bounding boxes 218 around all the apparel item(s) 220 in the selected image 212. For example, if the selected image includes a human model wearing a red shirt, khaki pants and white shoes, the object detection model 216 places a bounding box around the red shirt, another bounding box around the khaki pants, and at least one bounding box around the shoes. If both shoes are touching, a single bounding box is placed around both shoes. If the shoes are spaced apart, one bounding box is placed around the right shoe and another bounding box is placed around the left shoe.

The object detection model crops the image to isolate each apparel item. For example, if the selected item is the red shirt and the target complementary item is the khaki pants, the image is cropped to cut out the shoes and the red shirt leaving a cropped image 222 of the khaki pants, which is the anchor item. The selected image 212, in another example, is cropped to eliminate the shirt and pants leaving only the shoes. The selected image 212 can also be referred to as an anchor image.

The cropped image 222, in some examples, is used by the object detection model to identify a category 226 from a plurality of categories 228 of the apparel item in the cropped image 222. The plurality of categories 228 in this example includes one or more categories associated with a classification model 224.

In this example, the cropped image includes only the khaki pants. The object detection model places the khaki pants into a category for pants. In another example, if the cropped image 222 includes the shoes, the category 226 selected is footwear. In still other examples, if the cropped image includes the shoes as the complementary item, the image is cropped to eliminate the shirt and khaki pants. The cropped image of the shoes is then used to identify a category for footwear.

In other examples, an image similarity model 230 performs feature extraction 232 based on feature(s) 128 identified in a per-category similarity definition 126. The image similarity model 230 is a ML model, such as, but not limited to, the ML models 140. Each category includes a unique set of features used to determine similarity of each item with the complementary item 132. For example, the features of sleeve length, collar type, shape, and color can be used to identify items similar to an anchor item in the category for shirts/tops. In another example, features such as color, heel height, toe shape, fastener type, and style are used to identify items in a footwear category.

In still other examples, the image similarity model finds the most similar items of the same category as a complementary item. The attributes used to find the most similar items are unique to each category. The attributes define similarity for each item. For example, given an item in the catalog (the anchor) of a certain type (i.e., top, skirt, coat, etc.) which is complementary to the selected item, the image similarity model finds the most similar items of the same type. The attributes that make apparel similar for a given category include features such as, but not limited to, product type, color, shape and/or materials/texture.

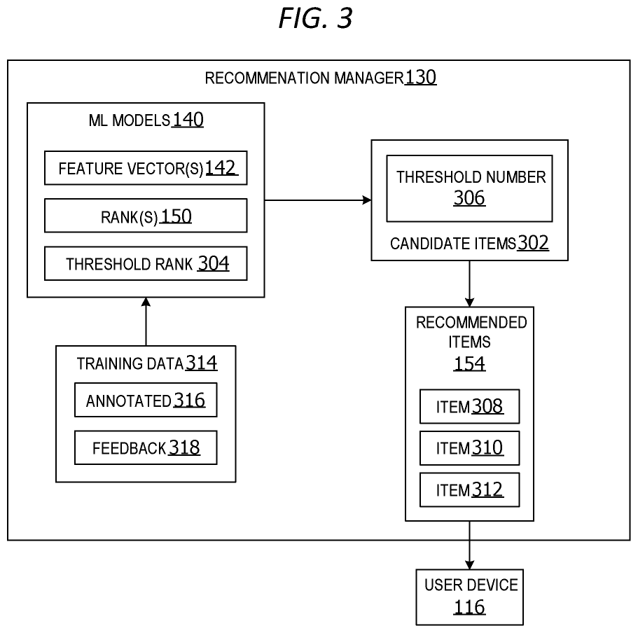

FIG. 3 is an exemplary block diagram illustrating a recommendation manager 130 including pre-trained ML models 140 for detecting and matching apparel objects. In some examples, the ML models 140 generate feature vector(s) 142 representing the complementary item and each candidate item in the plurality of candidate items 302. The candidate items 302 are items that are in-stock or otherwise available for purchase by the user. The candidate items 302 are in the same category of items as the complementary item. For example, if the complementary item is a blue coat in an outerwear category, all the candidate items are also apparel items in the outerwear category.

The ML models 140 utilize the feature vector values to generate rank(s) 150 for the candidate items 302. Each complementary item with a rank that exceeds a threshold rank 304 is added to a recommended items list 154. The threshold rank 304 is a threshold value used to determine whether an item is the same or similar to an anchor item. The threshold rank 304 in some examples is a default value. In other examples, the threshold rank is a user-configurable value. The threshold rank is implemented as any type of rank, such as, but not limited to, a percentage value, a numerical rank on a scale, a ratio, or any other type of rank. A rank on a scale is a scale of values within a range, such as, but not limited to, a scale from 0 to 1 or a scale from 1 to 10.

In some examples, a threshold number 306 of candidate items having a rank that exceeds the threshold is added to the recommended items list 154. For example, if the threshold number 306 is three, only three candidate items having the highest ranks are added to the recommended items list 154.

In this example, the recommended items list 154 includes three items, item 308, item 310, and item 312. However, the examples are not limited to three recommended items in the recommended items list. In other examples, the threshold number 306 of items added to the recommended items list 154 is a user configurable value. Therefore, the recommended items list 154 in some examples includes a single recommended item, two recommended items, four items, or any other number of recommended items. In this non-limiting example, the recommended items list 154 is presented or otherwise displayed to a user via the user device 116.

The ML models 140, in other examples, include a plurality of pre-trained ML models trained using training data 314 specific to a given catalog of apparel items. The training data 314 is annotated 316 with category and item descriptions. The ML models 140 is trained or updated using feedback 318 provided by human users.

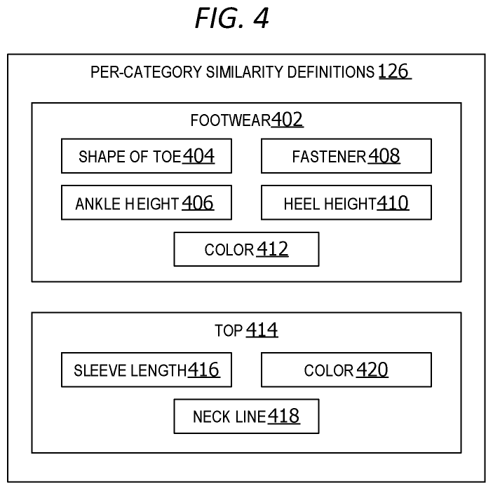

FIG. 4 is an exemplary block diagram illustrating per-category similarity definitions 126. For example, the category of footwear 402 includes shoes, boots, sandals, slippers, swimming shoes, etc. The category specific features used to determine similarities between a complimentary item identified in an image and candidate items available within a catalog of items are a unique set of two or more features specific to footwear. The features are selected to optimize object matching to ensure recommended items are as similar to the complementary items detected in the image on the PDP.

In this example, the per-category similarity definition in the per-category similarity definitions 126 for footwear 402 includes the shape of the toe 404, ankle height 406, fastener 408, heel height 410, color 412, and/or other attribute features pertinent to footwear. The shape of the toe 404 can include a square toe, pointed toe, rounded toe, open toe, etc. The ankle height 406 indicates whether the shoe is a high-top shoe covering the ankle. The fastener 408 feature indicates whether the shoe uses laces, buckles, hook and loop fasteners, no fastener (slip-on), etc. Heel height 410 is a feature which describes the height of the heel on the bottom of the shoe. There may be no heel (flats), a one-inch heel, etc. Color 412 indicates the color of the shoe. A shoe could be blue, red, white, black, brown, etc.

In this example, the set of features for determining whether a candidate item is similar to a complementary item in a full-body or partial body image of a selected item includes five features. In other examples, the per-category similarity definition includes any user-configurable number of features. In another example, the set of similarity features for footwear includes three features, six features or any other number of features.

In this example, the set of features used to identify candidate items in the category for tops 414 which are the same or similar to the complementary item includes three features, sleeve length 416, neckline 418 and color 420. The sleeve length 416 includes long sleeve length, short sleeve length, sleeveless, elbow length, mid-forearm (three-fourths) length, etc. The neckline 418 can include round neck, V-neck, etc. However, the examples are not limited to these described features. The similarity definition in other examples is user-configurable to include any features and any number of features.

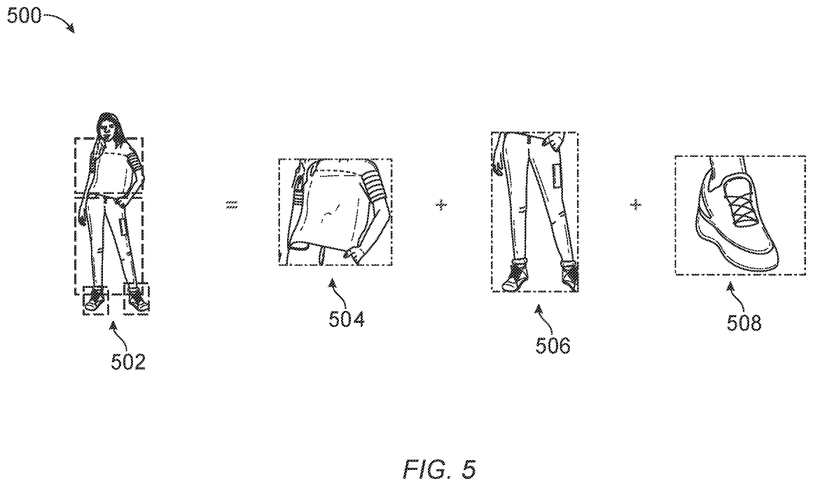

FIG. 5 is an exemplary screenshot 500 illustrating object detection using a full-body image 502 of a human model including complementary apparel items. In this example, the object detection model places a bounding box around each apparel item. The item within the bounding box is analyzed to determine its product type.

In some examples, the object detection model performs product type classification. For example, a first bounding box is placed around the shirt in the image, a second bounding box is placed around the pants are placed in a second bounding box, a third bounding box is placed around one shoe, and a fourth bounding box is placed around the second shoe. In this example, one bounding box is placed around the image of one shoe and another bounding box is placed around the other shoe. However, in other examples, if both shoes in the image are touching or otherwise in close proximity, a single bounding box is placed around both shoes.

The bounding boxes isolate each apparel item. The image is cropped based on the bounding boxes to separate each apparel item into a separate cropped image. For example, the shirt is placed in a first cropped image 504, the pants are placed in a second cropped image 506 and the shoes are shown in a third cropped image 508.

In some examples, the object detection model includes a first ML model trained for detecting clothing objects and a second ML model trained for detecting footwear. In these examples, the first ML model places bounding boxes around clothing items, such as shirts/tops, pants, skirts, dresses, outerwear, headwear, accessories, etc. Headwear includes hats, helmets, beanies, toboggans, Accessories includes scarves, handkerchiefs, gloves, etc.

The second ML model detects footwear and places bounding boxes around detected footwear in images including footwear. In one example, the system uses a crowd sourcing platform to gather training data to detect shoes and build a shoe detection/classification model.

The cropped images 504-508 are used to match similar candidate items with one or more complimentary items shown in the cropped image(s). If the cropped image 504 includes the user-selected item, then only the cropped image 506 and the cropped image 508 are used to identify similar candidate items for addition to the recommended items list.

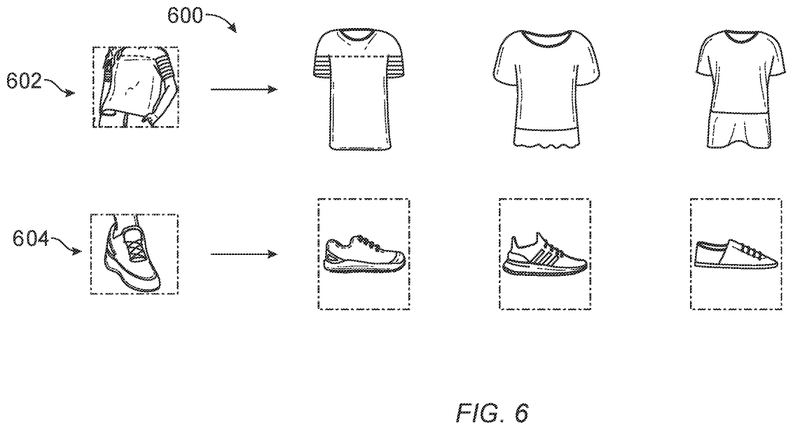

FIG. 6 is an exemplary diagram illustrating a cropped image 600 of a shirt 602 and a cropped image of a shoe 604 used to match similar items. In this example, the recommendation manager utilizes the plurality of ML models to identify three recommended items similar to the complementary item shown in each of the cropped images. The recommended items can include an item that is an exact match to the item shown in the cropped image. In other examples, the recommended items include similar apparel items that are not an exact match, but which have features that are very similar to the item in the cropped image.

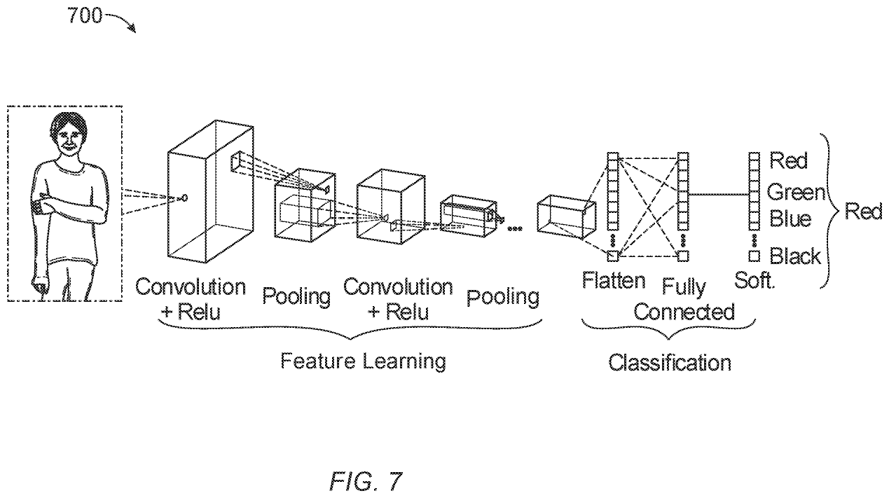

FIG. 7 is an exemplary diagram illustrating attribute feature extraction process 700 of an image of a complementary item. The image classification model, in some examples, obtains a feature vector from the last few layers of a convolutional neural network that encodes all pertinent features used to classify a shirt attribute in a cropped image. In this example, the classification model uses a color feature extraction to determine the color of an item in the shirt category. The feature vector values for various colors, such as red, green, blue, and black, are compared and analyzed. In this example, the feature vector values having the shortest distance with the anchor image indicate the shirt is a red color.

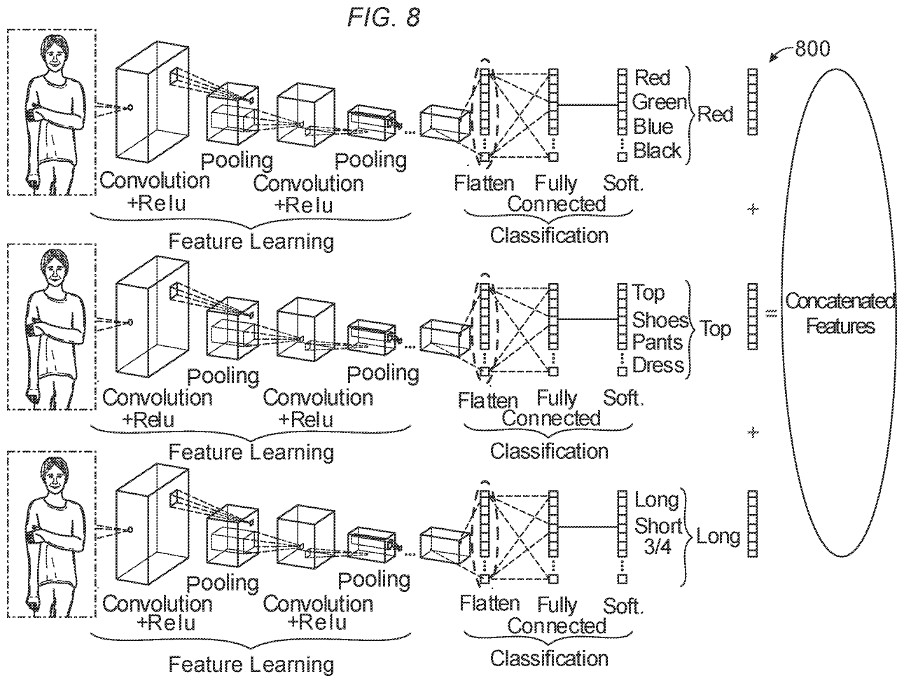

In this example, the feature vector values are analyzed to identify a color feature of the anchor image. In other examples, the feature vector values for other features are calculated to identify additional features for the item based on the item classification, as shown in FIG. 8 below.

FIG. 8 is an exemplary diagram 800 illustrating feature vector generation for an item of apparel depicted in an image. In this example, the feature vectors representing the color prediction, category prediction and sleeve-length prediction for an apparel item are shown. The image similarity model concatenates the feature vector values representing the color (red), the category (top/shirt) and the sleeve length (long) into a feature vector value representing the item. The feature vector values for the color feature are shown in greater detail in FIG. 7 above. The concatenated feature vectors representing the anchor item are concatenated to generate a feature vector representing the entire anchor item which is compared with feature vectors representing candidate items. If a candidate item feature vector is close in distance to the concatenated feature vector for the anchor item, the candidate item is the same or similar to the anchor item.

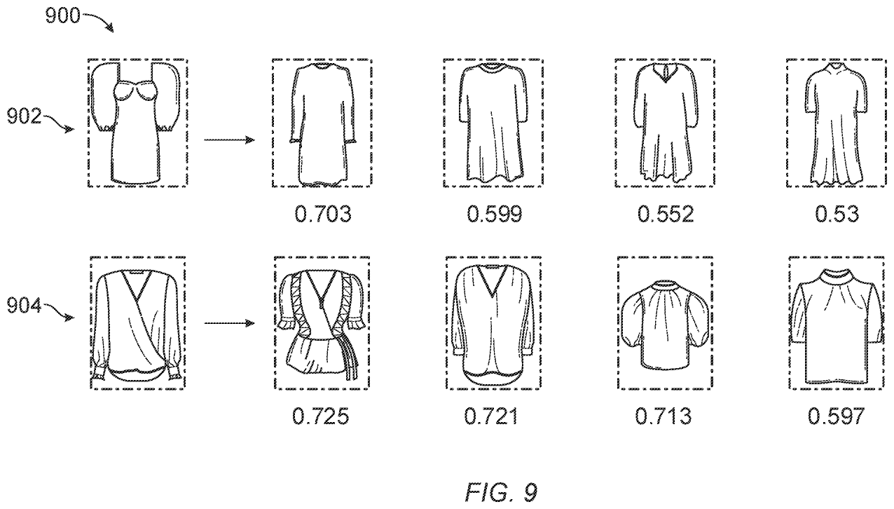

FIG. 9 is an exemplary diagram 900 illustrating rankings for a plurality of candidate items. In this example, the rank is generated for each item based on the concatenated feature vector value for each candidate item and the cosine similarity or other similarity metrics of concatenated feature vectors between the complementary item and the candidate item. A score of 1.0 indicates a perfect match with the complementary item. A score of 0.0 indicates no similarity. The higher the rank value/score the more similar the item is to the complementary (anchor) item. In this example, the item having a rank value of 0.703 is the most similar to the complementary item 902. Likewise, the item having the rank of 0.725 is the most similar to the complementary item 904.

In some examples, the system performs a similarity search using the feature vectors by calculating the distance between the anchor image showing the target complementary item and every other image in the candidate image data set. The cosine similarity or cosine distance method is used to calculate the distance between numerical vectors.

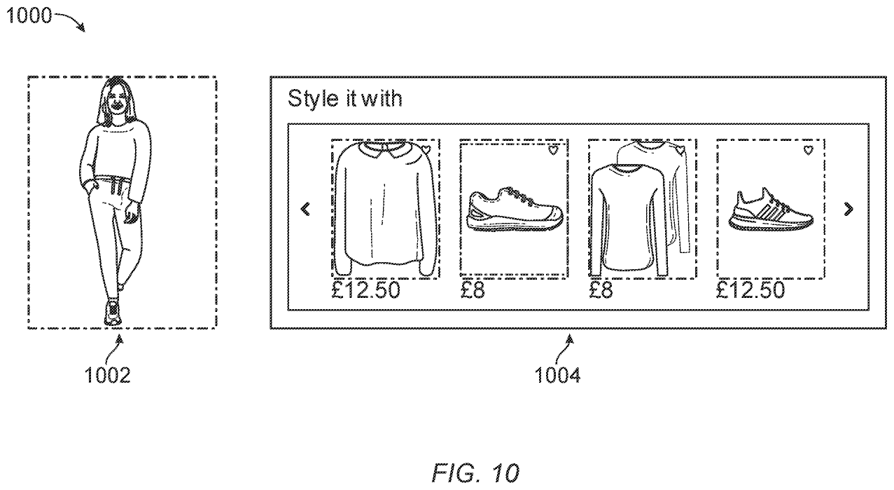

FIG. 10 is an exemplary diagram 1000 illustrating a selected full-body image 1002 and a list of recommended items 1004 in a PDP. The recommendation manager recommends complimentary apparel items from the human model full-body image 1002. The recommendation manager uses the product categories (types) from objects detected in the full-body image 1002 as complimentary product categories. For example, given the PDP for a top, the system recommends the items from complementary categories of jeans and shoes.

In this example, the full-body image 1002 is from a PDP for a pair of pants. The system recommends items from complementary categories. The complementary categories for the pants include a top and shoes. The list of recommended items includes two shirts similar to the top worn by the human model in the full-body image 1002. The list of recommended items also includes two different shoes similar to the shoes on the model shown in the full-body image 1002.

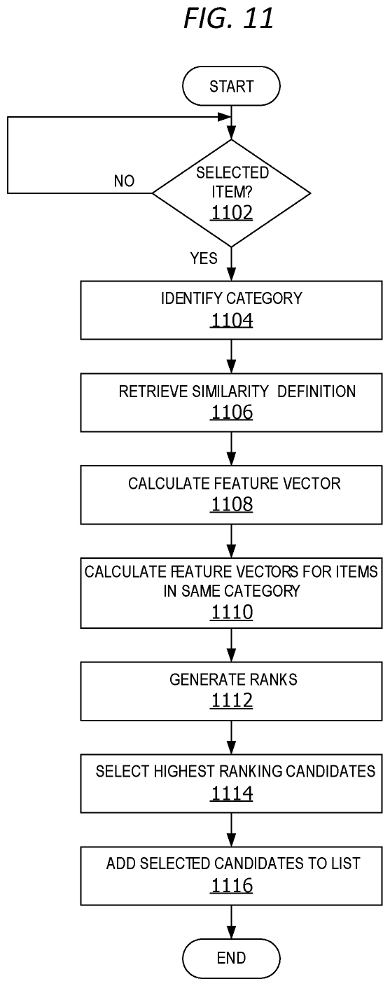

FIG. 11 is an exemplary flow chart illustrating operation of the computing device to identify apparel items similar to a complementary item in an image. The process shown in FIG. 11 is performed by a recommendation manager component, executing on a computing device, such as the computing device 102 or the user device 116 in FIG. 1.

The process begins by determining if an item has been selected at 1102. In some examples, a PDP displays one or more images of the selected item in one or more views. The recommendation manager identifies a category of a complementary item at 1104. A similarity definition defining features for the identified category is retrieved at 1106. A feature vector is calculated representing the complementary item at 1108. Feature vectors are calculated for candidate items in the same category at 1110. Ranks are generated for the candidate items based on the feature vectors at 1112. The highest-ranking candidates are selected at 1114. The selected candidates are added to a recommended items list at 1116. In some examples, the highest-ranking candidates include the items having a ranking which exceeds a threshold value. In still other examples, a threshold number of candidate items with the highest ranks are added to the recommended items list. In other examples, a highest-ranking candidate is added to the recommended items list is the candidate has a higher rank that is higher than the other candidates regardless of whether the rank exceeds a threshold value. The recommended items list is displayed to the user within the PDP page. The process terminates thereafter.

While the operations illustrated in FIG. 11 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 11.

FIG. 12 is an exemplary flow chart illustrating operation of the computing device to identify the top ranked similar items for recommendation to a user. The process shown in FIG. 11 is performed by a recommendation manager component, executing on a computing device, such as the computing device 102 or the user device 116 in FIG. 1.

An image classifier 1202 receives anchor product images 1204 and product catalog images 1206. The classifier determines the view of an image. Anchor product images 1204 are images including the target complementary item which is worn by a human model with the selected item which is displayed on PDP to the customers. The view of the image includes a full-body view, partial-body view, or item-only view. The full-body view and partial body view includes at least a portion of an image of a human model wearing a selected item and one or more complementary items. A predicted label is associated with the image. The label identifies the predicted type of image. In this example, the label is a full-body image label, a partial-body image label or a product-only image label.

A determination is made whether the anchor product is shown in a full-body image or a partial-body image at 1208. This determination is made based on the predicted label associated with each image showing the selected item. If the image is a full-body or partial body image showing a selected item with at least one complementary item, object detection 1210 is performed to detect clothes and shoe apparel objects within the image. The object detection model places a bounding box around each detected object in the image and its product type.

A determination is made whether the product type of the detected apparel in the bounding box is complementary at 1212. This determination is made by analyzing attributes of the items. For example, if the selected item is a shirt, attributes of an item in the bounding box indicating the item is a pair of shoes (shape, color, fasteners, toe shape, heel height), the item is a complementary item. If an item in a bounding box has attributes which are the same as the selected item, it is not a complementary item. If a complementary item is detected in a bounding box, the image is cropped to isolate the detected objects in the bounding boxes which are complementary to the selected item at 1214.

Returning to 1202, a determination is made whether a given image is a product only image at 1218. This determination is made based on the predicted label. If the label indicates it is a product-only image, a complimentary item is not shown. Only the selected item chosen by the user is shown in the product-only image of a PDP page. A classification (product type) is determined at 1220. For example, if the selected item is a running shoe, the category is footwear. If the item in the product only image is a blouse, the category is shirts/tops.

A feature extractor 1216 performs per-category feature extraction using unique, category specific similarity definitions. The similarity definition defines pertinent features which are extracted for each category. In this example, a shoes feature extractor calculates a feature vector representing footwear, a tops feature extractor calculates a feature vector representing shirts, and a pants feature extractor calculates feature vectors representing pants. The shoes feature extractor concatenates the feature vectors representing a combination of feature vectors unique to the footwear category. Likewise, the tops feature extractor concatenates feature vectors representing a unique combination of features for the category of tops.

If the selected image is a full-body image or partial image and contains a complimentary product type, the image qualifies for use as an anchor image which can be analyzed to identify the same or similar complementary items for recommendation to the user. In some examples, the partial-body image only shows the selected item without any other complementary items. In such cases, the partial-body image is not utilized by the system to identify apparel items for recommendation. The product-only images and partial-body images which do not include the anchor complementary item are disregarded for the purposes of generating recommendations.

In other examples, the system selects images of the model wearing the selected item that also includes at least one complementary item. If an image shows multiple complementary items, a single complementary item is selected as an anchor item and the images are cropped to isolate the anchor item in each image.

In other examples, the feature extractor utilizes cropped image features 1222 to calculate the cosine similarity 1226 representing the distance between the complementary item and the candidate items in the catalog. If the selected image is a product only image, the feature extractor uses product catalog image features 1224 to generate the feature vectors used to calculate the cosine similarity 1226. The top “N” ranked similar items (products) are added to a recommended items list for presentation to the user.

While the operations illustrated in FIG. 12 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 12.

FIG. 13 is an exemplary graph 1300 illustrating cosine similarity between concatenated feature vectors of two items. The cosine similarity is used to determine the distance between a first item and a second item, such as a complementary item and a candidate item. A shorter distance indicates a greater similarity between the two items. A greater distance indicates less similarity between the two items.

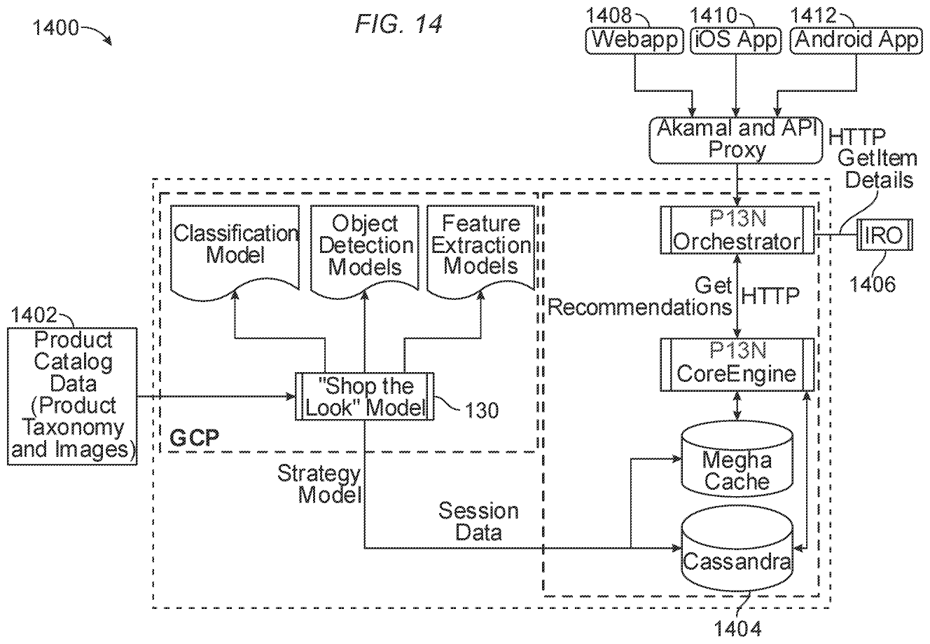

FIG. 14 is an exemplary block diagram 1400 representing a system architecture for generating similar item recommendations. In this example, the recommendation manager 130 hosted on a cloud platform obtains or otherwise receives product catalog data 1402 describing apparel item taxonomy and including images of apparel items. The recommendation manager includes a classification model, one or more object detection models and a plurality of feature extraction models. The classification model classifies images as full-body, partial-body, and item-only images. The object detection model detects clothing and shoe apparel items. In some examples, a first ML model is trained to detect clothing objects, such as outerwear, tops, pants, skirts, dresses, etc. A second ML model is trained to detect footwear. The plurality of feature extraction models includes a trained model for performing per-category feature extraction based on unique features defined for each category of items.

A database and cache are stored on a cloud computing platform 1404. The system obtains item details from an item details page at 1406. A user interacts with the system via an application on a user device, such as, but not limited to, the applications 1408, 1410 and 1412. The user device is any type of computing device, such as, but not limited to, the user device 116 in FIG. 1.

In this manner, the system provides recommendations for items which are complementary to a user-selected clothing item chosen in online shopping. As a customer browses through a product detail page (PDP) in apparel via an application on a user device, the user is offered a shop-the-look recommendation carousel which shows complimentary apparel items to the selected apparel item. The customer has the option to purchase all products worn by the model in the image, from categories complementary to the selected item. For example, if the customer is viewing a PDP for a top, the algorithm recommends the jeans, shoes, and hat worn by the fashion model in the product images or recommend items that are similar to these.

### Additional Examples

In some examples, the system extracts high level image features for different categories of items based on a combination of relevant attributes and unique combinations of features used for calculating vectors. The unique combinations of features for each category are defined in a per-category similarity definition, which provides a definition of what is similar with regard to specific categories of items.

In other examples, the ML models are trained using annotated datasets to build customized apparel item detection models and train the models to detect specific types of apparel items within a specific catalog of items. The pre-trained model utilizes labels to classify images and objects within the images.

In other examples, the recommendation manager includes one or more filter(s) used to filter candidate items from the pool of candidate items being considered as a recommendation for the user based on the selected item and complementary item shown in the full-body or partial-body image. The filter in some examples removes items that are out-of-stock such that only items which are currently available in-stock are considered. In other examples, the filter removes items which are a specific brand. In other items the filter removes items which are not included in a set of brands preferred by the user.

In other examples, the system recommends complementary items visible in an image of a human model. The system automatically detects complementary items in an image, searches for the same or similar items within the catalog and serves the top ranked similar items as a recommendation. In an example scenario, a user looking at jogging pants is provided recommendations for complementary tops and shoes which might match the look of the outfit worn by a model in the product image, enabling the user to shop-the-look. The system eliminates the need for a manual search and/or manual curation by the merchandising team while saving the customer time. The system further increases sales and customer engagement with the merchant website.

In an example scenario, an image classification selects the most suitable image of apparel items on a human model from a plurality of images of a selected item. Image classification involves image analysis to identify the full-body image(s) and/or partial-body images from the set of images. The most suitable image is selected and passed to the object detection model(s). The object detection model(s) detect apparel items in the selected image and place bounding boxes around different items visible in the image. The image is cropped to isolate each item inside a bounding box. For example, if three apparel items are detected, the image is cropped into three components (three cropped images). Each cropped image contains a single detected apparel object. The image similarity model performs semantic visual search to find the same item or similar items in the existing catalog making use of existing attributes in catalog, such as product type, color, shape, materials, texture.

In some examples, the image similarity model includes a convolutional neural network classifier. The convolutional neural network acts as a feature extractor to generate a numerical vector representation of the image which would be representative of some intrinsic quality of the image, such as color. The pertinent features for each category/type are encoded for the classification task. Labeled data is used to train the classifiers. The neural networks are used to predict features of the items, such as predicting color, predicting the item category (product type), predicting sleeve length, and other features. The feature vectors for a plurality of features are combined through concatenation. These combined feature vectors are a robust representation of a given image of an item. Using the feature vector, a similarity search is performed by calculating the distance between the anchor image and every other image in the image data set. The distance method is cosine similarity or cosine distance for calculating distance between numerical vectors. This enables the system to retrieve items in the same category having similar features, such as color, shape, sleeve length, type of fasteners, material/fabric, etc.

In other examples, some classifications, object detections and visual search components, such as feature vector values, are pre-computed. The values are stored in cache or database such that a customer searching for an item does not have to wait for the system to recompute everything. In this manner, some values can also be calculated offline for later use.

In still other examples, the recommended items are provided to the user via a recommended items carousel rather than a static list. The carousel enables the user to scroll through a horizontal presentation or display showing images and/or brief descriptions of the recommended items. The recommended items carousel is presented to the user via the PDP.

The recommendation system, in some examples, uses a combination of multiple deep neural network-based computer vision algorithms including image classification, object detection, and feature extraction. The system identifies the most suitable full-body and partial-body images for object detection, detects all apparel objects in these images, determines the complimentary product categories, and finds the exact or similar products using image features specific to each of the categories.

The system uses similar item attributes, such as type of item, color, shape/style, and materials/texture of the item to find matches. An attribute feature extraction obtains a feature vector that encodes pertinent features used to make classifications.

In other examples, the recommendation manager identifies items which are similar to a complementary item instead of items similar to a selected item. The system uses the item category of detected objects as complimentary item categories/types. The recommendation manager utilizes ML models to identify the most suitable image for object detection, such as a full-body image showing an unobstructed view of one or more complementary items.

Alternatively, or in addition to the other examples described herein, examples include any combination of the following:
perform object detection of clothing items using a first machine learning (ML) model pre-trained for identifying clothing items;
perform object detection of footwear within a selected image using a second ML model pre-trained for identifying footwear;
calculate a rank for a plurality of items in a first category using a first set of features defined by a first per-category similarity definition;
calculate a rank for a plurality of items in a second category using a second set of features defined by a second per-category similarity definition, wherein the first set of features comprises a different combination of features than the second set of features;
calculate a rank for a plurality of items in a footwear category using a set of features defined by a similarity definition for footwear, wherein the set of features comprises a toe shape feature, a color feature, and a heel height feature;
train a ML model using annotated images of an apparel item on a human model with bounding boxes enclosing the apparel item;
filter candidate items based on a brand of the candidate item; and
filter candidate items to remove any apparel item which is currently out-of-stock.

At least a portion of the functionality of the various elements in FIG. 1, FIG. 2, FIG. 3, FIG. 4, and FIG. 14 can be performed by other elements in FIG. 1, FIG. 2, FIG. 3, FIG. 4 and FIG. 14, or an entity (e.g., processor 106, web service, server, application program, computing device, etc.) not shown in FIG. 1, FIG. 2, FIG. 3, FIG. 4, and FIG. 14.

In some examples, the operations illustrated in FIG. 11 and FIG. 12 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of generating recommendations, the method comprising identifying a category of a complementary item appearing in an image of a selected item on a user interface device; retrieving a per-category similarity definition comprising a plurality of category-specific features for determining a degree of similarity between items within the identified category;

calculating a feature vector, by a pre-trained machine learning model, representing the complementary item, the feature vector comprising a concatenation of a plurality of feature vector values representing the plurality of category-specific features for the identified category; calculating a candidate feature vector representing each candidate item in a plurality of available items within the identified category; ranking each candidate item, the ranking indicating the degree of similarity between the complementary item and each candidate item; and generating a recommended items list comprising candidate items having a rank exceeding a threshold value. The recommended items list is presented to the user via the user interface device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for generating recommendations. For example, the elements illustrated in FIG. 1, FIG. 2, FIG. 3, FIG. 4, and FIG. 14, such as when encoded to perform the operations illustrated in FIG. 11 and FIG. 12, constitute exemplary means for identifying a category of a complementary item appearing in an image of a selected item on a user interface device; exemplary means for retrieving a per-category similarity definition comprising a plurality of category-specific features for determining a degree of similarity between items within the identified category; exemplary means for calculating a feature vector, by a pre-trained machine learning model, representing the complementary item, the feature vector comprising a concatenation of a plurality of feature vector values representing the plurality of category-specific features for the identified category; exemplary means for calculating a candidate feature vector representing each candidate item in a plurality of available items within the identified category; exemplary means for ranking each candidate item, the ranking indicating the degree of similarity between the complementary item and each candidate item; and exemplary means for generating a recommended items list comprising candidate items having a rank exceeding a threshold value, wherein the recommended items list are presented to the user via the user interface device.

Other non-limiting examples provide one or more computer storage devices having a first computer-executable instructions stored thereon for providing item recommendations. When executed by a computer, the computer performs operations including identifying a category of a complementary item appearing in an image of a selected item on a user interface device; retrieving a per-category similarity definition comprising a plurality of category-specific features for determining a degree of similarity between items within the identified category; identifying a plurality of available items within a catalog associated with the identified category; calculating a feature vector representing the complementary item, the feature vector comprising a concatenation of a plurality of feature vector values representing the plurality of category-specific features for the identified category; calculating a plurality of feature vector values representing each candidate item in the plurality of candidate items; generating a ranking for each candidate item using the plurality of feature vector values, the ranking representing the degree of similarity between the complementary item and each candidate item; and selecting candidate items having a rank exceeding a threshold value, wherein the selected candidate items are presented to a user as recommended complementary items available for purchase.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for complementary item recommendations, the system comprising:
at least one processor; and
at least one memory comprising computer-readable instructions, the computer-readable instructions configured to cause the at least one processor to:
retrieve a per-category similarity definition comprising a plurality of category-specific features for determining a degree of similarity between items within an identified category;
calculate a feature vector, by a pre-trained machine learning model, representing a complementary item and each candidate item in a plurality of candidate items, the feature vector comprising a concatenation of a plurality of feature vector values representing the plurality of category-specific features for the identified category, wherein each candidate item is an item in the identified category that is available for purchase;
rank each candidate item using the feature vector for each candidate item, wherein the ranking indicates the degree of similarity between the complementary item and each candidate item; and
generate a list of recommended items comprising a candidate item having a rank exceeding a threshold value, wherein a threshold number of items on the list of recommended items are presented to a user.

2. The system of claim 1, wherein the computer-readable instructions are further configured to cause the at least one processor to:
perform object detection of clothing items using a first machine learning (ML) model pre-trained for identifying apparel items; and
perform object detection of footwear within an image using a second pre-trained ML model.

3. The system of claim 1, wherein the computer-readable instructions further cause the at least one processor to:
calculate a first rank for a plurality of items in a first category using a first set of features defined by a first per-category similarity definition; and
calculate a second rank for a plurality of items in a second category using a second set of features defined by a second per-category similarity definition, wherein the first set of features comprises a different combination of features than the second set of features.

4. The system of claim 1, wherein the computer-readable instructions further cause the at least one processor to:
calculate a third rank for a plurality of items in a footwear category using a set of features defined by a similarity definition for footwear, wherein the set of features comprises at least one of a toe shape feature, a color feature, a heel height feature.

5. The system of claim 1, wherein the computer-readable instructions further cause the at least one processor to:
train a ML model using annotated images of an apparel item on a human model with bounding boxes enclosing the apparel item.

6. The system of claim 1, wherein the computer-readable instructions further cause the at least one processor to:
filter candidate items based on a brand.

7. The system of claim 1, wherein the computer-readable instructions further cause the at least one processor to:
filter candidate items to remove any apparel item which is currently out-of-stock.

8. A method for recommending complementary apparel items, the method comprising:
identifying a category of a complementary item appearing in an image of a selected item on a user interface device;
retrieving a per-category similarity definition comprising a plurality of category-specific features for determining a degree of similarity between items within the identified category;
calculating a feature vector, by a pre-trained machine learning model, representing the complementary item, the feature vector comprising a concatenation of a plurality of feature vector values representing the plurality of category-specific features for the identified category;
calculating a candidate feature vector representing each candidate item in a plurality of available items within the identified category;
ranking each candidate item using the candidate feature vector representing each candidate item, the ranking indicating the degree of similarity between the complementary item and each candidate item; and
generating a recommended items list comprising candidate items having a rank exceeding a threshold value.

9. The method of claim 8, further comprising:
performing object detection of clothing items using a first machine learning (ML) model pre-trained for identifying apparel items; and
performing object detection of footwear within the image using a second ML model pre-trained for identifying the footwear.

10. The method of claim 8, further comprising:
calculating a first rank for a plurality of items in a first category using a first set of features defined by a first per-category similarity definition; and
calculating a second rank for a plurality of items in a second category using a second set of features defined by a second per-category similarity definition, wherein the first set of features comprises a different combination of features than the second set of features.

11. The method of claim 8, further comprising:
calculating a third rank for a plurality of items in a footwear category using a set of features defined by a similarity definition for footwear, wherein the set of features comprises a toe shape feature, a color feature, and a heel height feature.

12. The method of claim 8, further comprising:
training a ML model using annotated images of an apparel item on a human model with bounding boxes enclosing the apparel item.

13. The method of claim 8, further comprising:
filtering the candidate items based on a brand.

14. The method of claim 8, further comprising:
filtering the candidate items to remove any apparel item which is currently out-of-stock.

15. A computer storage device having computer-executable instructions for complementary item recommendations that, when executed by a computer cause the computer to perform operations comprising:
identify a category of a complementary item appearing in an image of a selected item on a user interface device;
retrieve a per-category similarity definition comprising a plurality of category-specific features for determining a degree of similarity between items within the identified category;
identify a plurality of available items within a catalog associated with the identified category;
calculate a complementary item feature vector representing the complementary item, the feature vector comprising a concatenation of a plurality of feature vector values representing the plurality of category-specific features for the identified category;
calculate a plurality of candidate feature vector values representing each candidate item in a plurality of candidate items;
generate a ranking for each candidate item using the plurality of candidate feature vector values, the ranking representing the degree of similarity between the complementary item and each candidate item; and
select candidate items having a rank exceeding a threshold value, wherein a selected candidate item is presented to a user as a recommended complementary item available for purchase.

16. The computer storage device of claim 15, wherein the computer-executable instructions are further executed to perform operations comprising:
perform object detection of clothing items using a first machine learning (ML) model pre-trained for identifying apparel items; and
perform object detection of footwear within the image using a second ML model pre-trained for identifying footwear.

17. The computer storage device of claim 15, wherein the computer-executable instructions are further executed to perform operations comprising:
calculate a first rank for a plurality of items in a first category using a first set of features defined by a first per-category similarity definition; and
calculate a second rank for a plurality of items in a second category using a second set of features defined by a second per-category similarity definition, wherein the first set of features comprises a different combination of features than the second set of features.

18. The computer storage device of claim 15, wherein the computer-executable instructions are further executed to perform operations comprising:
calculate a third rank for a plurality of items in a footwear category using a set of features defined by a similarity definition for footwear, wherein the set of features comprises at least one of a toe shape feature, a color feature, and a heel height feature.

19. The computer storage device of claim 15, wherein the computer-executable instructions are further executed to perform operations comprising:
train a ML model using annotated images of an apparel item on a human model with bounding boxes enclosing the apparel item.

20. The computer storage device of claim 15, wherein the computer-executable instructions are further executed to perform operations comprising:
filter candidate items based on a brand.
